(19) United States
(12) Patent Application Publication
(10) Pub. No.: US 2009/0088317 A1
(43) Pub. Date: Apr. 2, 2009

(54) Multi-metal reduction catalysts and methods of producing reduction catalysts

(76) Inventors: John G. Frye, JR., Richland, WA (US); Johnathan E. Holladay, Kennewick, WA (US); Danielle S. Muzatko, Kennewick, WA (US); James F. White, Richland, WA (US); Alan H. Zacher, Pasco, WA (US)

Correspondence Address: WELLS ST. JOHN P.S., 601 WEST FIRST AVENUE, SUITE 1300, SPOKANE, WA, 99201-3828, US

(21) Appl. No.: 11/904,794

(22) Filed: Sep. 28, 2007

(51) Int. Cl. B01J 27/224; B01J 23/10; B01J 23/06; B01J 23/20; B01J 23/26; B01J 23/28; B01J 23/30; B01J 23/34; B01J 23/36; B01J 23/42; B01J 23/44; B01J 23/46; B01J 23/50; B01J 23/52; B01J 23/56; B01J 23/72; B01J 23/745; B01J 23/75; B01J 23/755; B01J 21/08; B01J 27/22

(52) U.S. Cl. 502/178; 502/324; 502/325; 502/337; 502/338; 502/339; 502/343; 502/347; 502/344; 502/307; 502/305; 502/315; 502/316; 502/313; 502/317; 502/319; 502/321; 502/345; 502/241; 502/243; 502/253; 502/349; 502/350; 502/353; 502/303; 502/259; 502/262; 502/261; 502/258; 502/177; 502/326; 502/328

(57) ABSTRACT

A reduction catalyst having a first metal component comprising one of Co, Os, Fe, Re, Rh and Ru. The first metal component is present in the catalyst at from 0.5 percent to 20 percent, by weight. A second metal component differing from the first metal component present in the catalyst with the second metal component being selected from the group consisting of Fe, Mn, Ru, Os, Rh, Ir, Ni, Pd, Pt, Ag, Au, Zn, Co, Re, Cu, Pb, Cr, W, Mo, Sn, Nb, Cd, Te, V, Bi, Ga and Na. A hydrogenation catalyst comprising one or both of Ni and Co and one or more elements selected from the group consisting of Mn, Fe, Ag, Au, Mo and Rh.

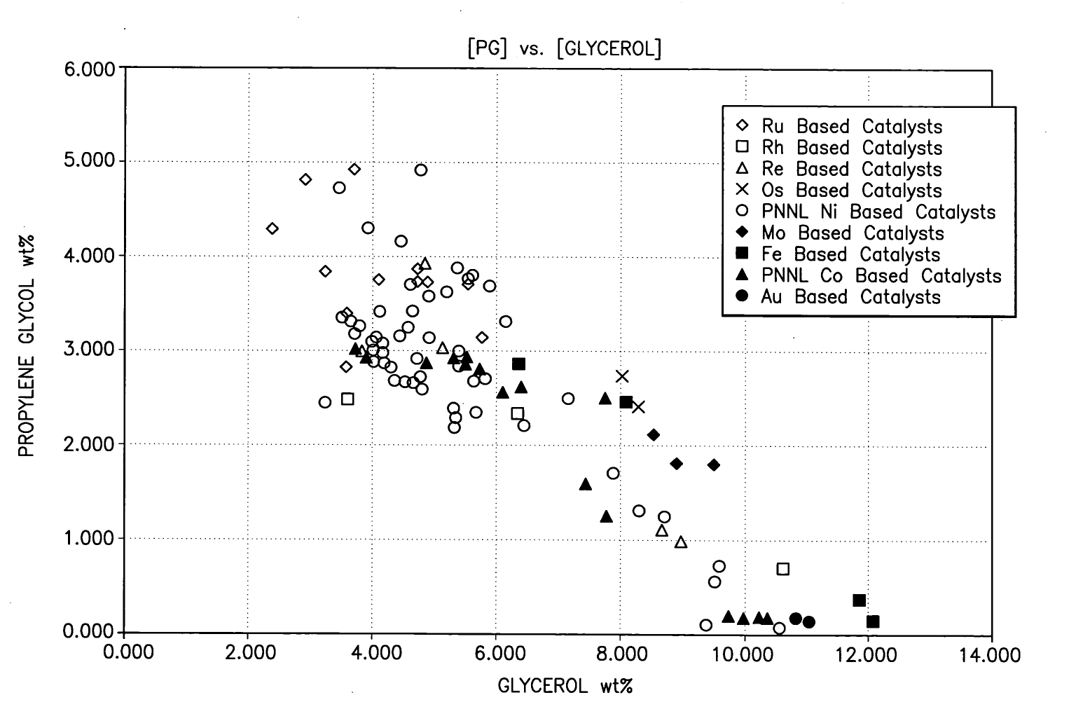

### GOVERNMENT RIGHTS

This invention was made with Government support under Contract DE-AC0676RLO1830 awarded by the U.S. Department of Energy. The Government has certain rights in the invention.

### TECHNICAL FIELD

The invention pertains to reduction catalysts.

### BACKGROUND OF THE INVENTION

Reduction reactions such as hydrogenolysis of polyols, for example sugar alcohols, to form lower molecular weight polyols is a commercially important technology area. Of particular interest recently is the conversion of glycerol to reduction products such as propylene glycol. Conventional catalysts available for this conversion have been shown to have low product yields, low selectivity or both. Accordingly, it is desirable to develop new catalysts for production of propylene glycol from glycerol.

### SUMMARY OF THE INVENTION

One aspect of the invention includes a reduction catalyst having a first metal component comprising one of Co, Os, Fe, Re, Rh and Ru. The first metal component is present in the catalyst at from 0.5% to 20%, by weight. A second metal component differing from the first metal component present in the catalyst with the second metal component being selected from the group consisting of Fe, Mn, Ru, Os, Rh, Ir, Ni, Pd, Pt, Ag, Au, Zn, Co, Re, Cu, Pb, Cr, W, Mo, Sn, Nb, Cd, Te, V, Bi, Ga and Na.

In one aspect the invention includes a hydrogenation catalyst comprising one or both of Ni and Co and one or more elements selected from the group consisting of Mn, Fe, Ag, Au, Mo and Rh.

### BRIEF DESCRIPTION OF THE DRAWING

Preferred embodiments of the invention are described below with reference to the following accompanying drawing.

The FIGURE shows glycerol conversion to propylene glycol for the various indicated metal-based catalysts.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

In general the invention includes multi-metal reduction catalysts which may be useful, for example, for hydrogenolysis of polyols to produce lower molecular weight polyols. The catalysts are described specifically with respect to hydrogenolysis of glycerol to produce glycerol reduction products such as propylene glycol. However, it is to be understood that the reduction catalyst of the invention can be utilized for reduction of higher molecular weight polyols, preferably for hydrogenolysis of higher molecular weight sugar alcohols.

The multi-metal reduction catalyst of the invention can be binary metal catalysts or can alternatively be higher order metal catalysts, where “higher order” refers to a catalyst having more than two catalytic metal components. The two or more catalytic components can be provided to be present on a support material such as a carbon based support material, an oxide support material, a carbide support material or an oxycarbide support material. Example preferred support materials include a variety of carbon based support materials, zirconium oxide, titanium oxide, niobium oxide, tin oxide, lanthanum oxide, tungsten oxide, silicon carbide, silicon oxycarbide, titanium carbide, titanium oxycarbide, zirconium carbide, zirconium oxycarbide, tungsten carbide and tungsten oxycarbide.

Porosity of the support material is not limited to a particular value. However, in particular applications it may be preferable to provide a mesoporous or macroporous support material.

Reduction catalysts of the invention will typically comprise a first metal component selected from Co, Os, Fe, Re, Rh, Ni and Ru. The first metal component will typically be present in the catalyst at from about 0.5 percent to about 20 percent by weight of the overall catalyst (dry weight). A preferred value of first metal component present in a particular catalyst can depend upon the particular metal utilized. For example, a preferred amount of nickel and/or cobalt can be from about two percent to about ten percent by weight of metal on the support.

Reduction catalysts in accordance with the invention can comprise a second metal component which differs from the first metal component and is selected from the group consisting of Fe, Mn, Ru, Os, Rh, Ir, Ni, Pd, Pt, Ag, Au, Zn, Co, Re, Cu, Pb, Cr, W, Mo, Sn, Nb, Cd, Te, V, Bi, Ga and Na with particular of these elements being preferred in combination with specific first metal components. For example, when the first metal component comprises Co the second metal component can preferably comprise a member of the group consisting of Fe, Mn, Ru, Os, Rh, Ir, Ni, Pd, Pt, Au, Ag and Zn. Where the first metal component is Fe, the second metal component can preferably be a member of the group consisting of Co, Mn, Re, Ru, Os, Ir, Ag, Au, Zn, Ni, Pd, Pt, Rh and Cu. When the first metal component is Os, the second metal component can preferably comprise a member of the group consisting of Co, Mn, Re, Ru, Fe, Ir, Ag, Au, Zn, Ni, Pd, Pt, Rh and Cu.

Where the first metal component is Re, the second metal component can preferably comprise a metal selected from the group consisting of Pb, Cr, W, Mo, Mn, Zn, Sn, Fe, Nb, Cd, Te, V and Na. Where the catalyst includes a first metal comprising Ru, the second metal can preferably be selected from the group consisting of Cd, Sn, Cu, Pb, Bi, Au, Ag, Ga and Te. Where the catalyst comprises a first metal component comprises Ni, Co or a combination of both Ni and Co, the second metal component can preferably be selected from the group consisting of Mn, Fe, Ag, Au, Mo and Rh. Where the reduction catalyst includes first metal component Rh, the second metal component can preferably include a metal selected from the group consisting of Fe and Os.

The amount of secondary metal present in a particular catalyst can depend upon a number of factors including the amount of first metal utilized, the particular second metal utilized and the presence of any higher order metals. Accordingly, the amount of secondary metal present on a catalyst is not limited to a particular value. Typically, the amount of secondary metal will be provided on a weight:weight ratio based upon the weight of the first metal utilized.

Where the catalyst is a binary catalyst or a ternary catalyst comprising cobalt and nickel, the amount of secondary metal present can preferably be from 0.1 percent to five percent, and more preferably from one percent to three percent.

Where one or more higher-order metals are present in the catalyst of the invention, the higher order element(s) can be selected from the group of elements listed as secondary metals for a given primary metal. In the case of Co being the first metal component, a higher order metal can be further selected from the group consisting of Rh, Cr, Re, Mo, W and Cu. Where the first metal component is Fe or Os, the higher order metal(s) can further be selected from the group consisting of Cr, Mo and W.

The amount of higher order metal present can typically be less than or equal to the amount of secondary metal present. Preferably, the amount of higher order metal(s) will be from one percent to ten percent by weight.

Numerous catalysts in accordance with the invention were prepared and were studied for ability to reduce glycerol and for selected production of propylene glycol. The results of example studies are set forth in Tables 1 and 2.

TABLE 1
Catalytic Reduction of Glycerol with greater than 2.5% propylene
glycol yield

| | | Average | Average | Average | PG | Glycerol | Molar |
|---|---|---|---|---|---|---|---|
| | Metal Composition | [Glycerol]† | [EG]† | [PG]† | Selectivity† | Conversion† | Balance† |
| 1 | 7Ni + 1Re | 4.76 | 0.28 | 4.92 | 113.77 | 52.36 | 111.40 |
| 2 | 5Ru + 1Cd | 3.70 | 0.22 | 4.92 | 94.51 | 63.01 | 99.78 |
| 5 | 5Ru + 1Cd | 2.92 | | 4.82 | 82.30 | 70.84 | 87.46 |
| 6 | 7Ni + 1Re | 3.449 | 0.521 | 4.731 | 87.40 | 65.52 | 99.47 |
| 10 | 5Ru + 1Cd | 2.390 | 0.562 | 4.295 | 68.31 | 76.10 | 84.23 |
| 11 | 7Ni + 1Re | 4.45 | 0.23 | 4.17 | 90.86 | 55.52 | 98.33 |
| 13 | 5Ru + 1Pb | 4.84 | 0.19 | 3.94 | 92.36 | 51.62 | 98.93 |
| 14 | 5Ni + 1Mn | 5.35 | 0.13 | 3.87 | 100.68 | 46.50 | 102.27 |
| 15 | 5Ru + 1Ag | 4.72 | 0.18 | 3.87 | 88.64 | 52.79 | 96.70 |
| 16 | 5Ru + 1Cd | 3.237 | 0.000 | 3.844 | 68.79 | 67.63 | 78.90 |
| 17 | 5Ni + 1Mn | 5.59 | 0.13 | 3.79 | 104.08 | 44.09 | 103.69 |
| 18 | 5Ru | 4.107 | 0.540 | 3.761 | 77.24 | 58.93 | 94.60 |
| 19 | 5Ni + 1Fe | 5.55 | 0.13 | 3.76 | 102.10 | 44.54 | 102.83 |
| 20 | 5Ru + 1Te | 4.73 | 0.16 | 3.75 | 86.03 | 52.73 | 94.98 |
| 21 | 5Ru + 1Cu | 4.87 | 0.17 | 3.73 | 87.91 | 51.34 | 96.25 |
| 22 | 5Ru + 1Sn(IV) | 5.54 | 0.14 | 3.72 | 100.93 | 44.58 | 102.54 |
| 23 | 2.5Co + 0.45Pd + 2.4Re | 5.22 | 0.13 | 3.71 | 93.99 | 47.81 | 99.06 |
| 24 | 7Ni + 1Mo | 4.613 | 0.573 | 3.705 | 83.24 | 53.87 | 99.48 |
| 25 | 5Ni + 1Cr | 5.88 | 0.12 | 3.70 | 108.52 | 41.21 | 105.31 |
| 27 | 5Ni + 1Zn | 5.20 | 0.12 | 3.62 | 91.42 | 47.98 | 97.70 |
| 28 | 7Ni + 1Re | 4.897 | 0.388 | 3.575 | 84.79 | 51.03 | 98.00 |
| 29 | 5Ni + 1Mn | 4.665 | 0.449 | 3.424 | 77.68 | 53.35 | 94.75 |
| 30 | 7Ni + 1Re | 4.115 | 0.203 | 3.406 | 70.04 | 58.85 | 85.37 |
| 31 | 5Ru + 1Cd | 3.582 | 0.000 | 3.393 | 63.98 | 64.18 | 76.88 |
| 32 | 6Ni + 1.2Re | 3.542 | 0.172 | 3.363 | 63.03 | 64.58 | 78.68 |
| 34 | 5Ni + 1.5Re | 3.644 | 0.217 | 3.325 | 63.31 | 63.56 | 79.90 |
| 35 | 5Ni + 1Cu | 6.13 | 0.10 | 3.31 | 103.49 | 38.66 | 102.83 |
| 37 | 7Ni + 1Fe + 0.5Pd | 4.552 | 0.156 | 3.249 | 72.17 | 54.48 | 87.15 |
| 38 | 5Ni + 1Re | 3.770 | 0.166 | 3.238 | 62.91 | 62.30 | 79.35 |
| 39 | 4.9Ni + 1.5Re | 3.718 | 0.142 | 3.189 | 61.44 | 62.82 | 77.89 |
| 41 | 4.9Ni + 0.7Re | 4.426 | 0.330 | 3.161 | 68.64 | 55.74 | 87.42 |
| 42 | 5Ru + 1.46Au | 5.768 | 0.183 | 3.144 | 89.92 | 42.32 | 98.45 |
| 44 | 4.9Ni + 0.7Re | 4.068 | 0.144 | 3.144 | 64.14 | 59.32 | 80.87 |
| 46 | 4.9Ni + 0.7Re | 3.991 | 0.140 | 3.109 | 62.62 | 60.09 | 79.61 |
| 48 | 4.9Ni + 0.7Re | 4.135 | 0.140 | 3.090 | 63.76 | 58.65 | 80.81 |
| 49 | 5Ru + 1Au | 5.122 | 0.175 | 3.057 | 75.85 | 48.78 | 90.82 |
| 50 | 6Ni + 1.25Re | 4.091 | 0.140 | 3.012 | 61.69 | 59.09 | 79.44 |
| 51 | 5Ru + 0.8S | 3.831 | 0.058 | 3.006 | 58.98 | 61.69 | 75.54 |
| 52 | 2.5Co + 0.35Ru + 2.5Re | 3.730 | 0.182 | 2.998 | 57.86 | 62.70 | 76.29 |
| 53 | 5Ni + 0.75Re | 4.144 | 0.148 | 2.995 | 61.89 | 58.56 | 79.88 |
| 54 | 7Ni + 1Pd + 2.5Re | 4.030 | 0.446 | 2.992 | 60.65 | 59.70 | 83.12 |
| 55 | 4.6Ni + 0.657Re | 5.387 | 0.762 | 2.983 | 78.26 | 46.13 | 101.28 |
| 56 | 2.5Co + 0.5Pt + 2.5Re | 3.756 | 0.056 | 2.972 | 57.60 | 62.44 | 74.35 |
| 58 | 7Ni + 1Fe + 1Re | 4.719 | 0.058 | 2.921 | 66.95 | 52.81 | 83.41 |
| 59 | 2.6Co + 0.2Pd + 2.55Re | 5.526 | 0.000 | 2.912 | 78.76 | 44.74 | 90.50 |
| 60 | 2.5Co + 2.4Re + 0.20Pd | 3.903 | 0.000 | 2.895 | 57.45 | 60.97 | 74.06 |
| 61 | Co + Re + Pd | 5.306 | 0.000 | 2.889 | 74.47 | 46.94 | 88.02 |
| 62 | 4.9Ni + 0.7Re | 4.005 | 0.067 | 2.881 | 58.16 | 59.95 | 75.91 |
| 63 | 5Fe + 1Rh | 6.315 | 0.409 | 2.870 | 94.26 | 36.85 | 103.96 |
| 65 | 4.9Ni + 0.7Re | 4.204 | 0.063 | 2.861 | 59.73 | 57.96 | 77.60 |
| 66 | 2.5Co + 1.5Re + 0.45Pd | 4.878 | 0.000 | 2.860 | 67.58 | 51.22 | 83.39 |
| 67 | 7Ni + 1Mn | 5.388 | 0.124 | 2.851 | 74.82 | 46.12 | 90.23 |
| 68 | 2.5Co + 0.45Pd + 2.4Re | 5.496 | 0.000 | 2.847 | 76.51 | 45.04 | 89.42 |
| 69 | 2.5Ru | 3.566 | 0.789 | 2.825 | 53.13 | 64.34 | 81.55 |
| 70 | 4.9Ni + 0.7Re | 4.295 | 0.066 | 2.824 | 59.91 | 57.05 | 78.11 |
| 71 | 4.9Co + 0.7Re | 5.739 | 0.123 | 2.793 | 79.34 | 42.61 | 93.02 |
| 72 | 5Os + 1Rh | 8.02 | 0.20 | 2.74 | 167.97 | 19.77 | 116.37 |
| 73 | 4.4Ni + 1.5Re | 4.752 | 0.121 | 2.715 | 62.62 | 52.48 | 82.18 |
| 74 | 4.6Ni + 0.657Re | 5.820 | 0.638 | 2.714 | 78.56 | 41.80 | 100.51 |
| 75 | 2.5Ni + 0.45Pd + 2.4Re | 4.370 | 0.059 | 2.688 | 57.78 | 56.30 | 77.10 |
| 76 | 6Ni + 1.0Re | 4.535 | 0.118 | 2.681 | 59.38 | 54.65 | 79.55 |
| 77 | 7Ni + 0.3Fe | 5.640 | 0.118 | 2.678 | 74.35 | 43.60 | 90.56 |
| 78 | 4.9Ni + 0.7Re | 4.677 | 0.636 | 2.669 | 60.69 | 53.23 | 88.51 |
| 79 | 2.5Co + 0.75Re + 0.45Pd | 6.380 | 0.000 | 2.609 | 87.23 | 36.20 | 95.38 |
| 80 | 4.9Ni + 0.7Re | 4.809 | 0.059 | 2.603 | 60.68 | 51.91 | 80.46 |
| 81 | 2.5Co + 0.1Pd + 2.4Re | 6.114 | 0.000 | 2.555 | 79.58 | 38.86 | 92.06 |

TABLE 2
Catalytic Reduction of Glycerol with less than 2.5% propylene glycol
yield

| Experiment ID | | | Reduction | Average | Average | Average | PG | Glycerol | Molar |
|---|---|---|---|---|---|---|---|---|---|
| No. | Catalyst No. | Metal Composition | Parameters† | [Glycerol]† | [EG]† | [PG]† | Selectivity† | Conversion† | Balance† |
| 101740 | 58959-140-5 | 5Ni + 1Ag | 1 | 7.15 | 0.08 | 2.50 | 106.11 | 28.52 | 102.93 |
| 101740 | 58959-140-7 | 5Co + 1Rh | 1 | 7.74 | 0.14 | 2.49 | 133.35 | 22.59 | 109.58 |
| 101679/101680 | 58959-43-3 | 5Rh + 2.4Re + 0.5Pd | 1 | 3.592 | 0.926 | 2.485 | 46.94 | 64.08 | 79.74 |
| 101740 | 58959-128-1 | 5Fe + 1Rh | 1 | 8.05 | 0.09 | 2.47 | 153.46 | 19.49 | 111.76 |
| 101679/101680 | 58959-111-1c | 50Ni + 50ZrO2 | 1 | 3.240 | 1.387 | 2.441 | 43.70 | 67.60 | 82.52 |
| 101740 | 58959-128-2 | 5Os + 1Rh | 1 | 8.30 | 0.10 | 2.41 | 171.20 | 17.04 | 113.55 |
| 101679/101680 | 58959-72-1 | 4.9Ni + 0.7Re | 1 | 5.314 | 0.061 | 2.380 | 61.45 | 46.86 | 82.84 |
| 101679/101680 | 58959-42-3 | 7Ni + 0.5Fe + 0.5Pd | 1 | 5.679 | 0.382 | 2.352 | 65.88 | 43.21 | 90.92 |
| 101679/101680 | 58959-43-4 | 6.15Rh + 0.5Re | 1 | 6.350 | 0.239 | 2.334 | 77.40 | 36.50 | 95.30 |
| 101679/101680 | 58959-80-2 | 4.9Ni + 0.7Re | 1 | 5.344 | 0.643 | 2.297 | 59.71 | 46.56 | 90.79 |
| 101679/101680 | 58959-42-2 | 7Ni + 0.5Fe | 1 | 6.440 | 0.000 | 2.212 | 75.18 | 35.60 | 91.16 |
| 101679/101680 | 58959-112-1c | 50Ni + 5Fe + 45ZrO2 | 1 | 5.332 | 0.856 | 2.195 | 56.90 | 46.68 | 92.59 |
| 101740 | 58959-140-6a | 5Mo + 1Rh | 1 | 8.54 | 0.18 | 2.11 | 174.21 | 14.65 | 113.50 |
| 101740 | 58959-140-6b | 5Mo + 1Rh | 1 | 8.90 | 0.10 | 1.81 | 198.85 | 10.99 | 112.34 |
| 101740 | 58959-140-6 | 5Mo + 1Rh | 1 | 9.50 | 0.10 | 1.79 | 435.72 | 4.97 | 118.13 |
| 101679/101680 | 58959-59-4 | 4.9Ni + 0.7Re | 1 | 7.878 | 0.000 | 1.711 | 97.62 | 21.22 | 99.49 |
| 101723 | 58959-130-1 | 2.5Co + 0.45Pd + 2.4Re | 2 | 7.43 | 0.48 | 1.58 | 74.67 | 25.67 | 100.61 |
| 101679/101680 | 58959-51-4 | 5Ni + 0.22Fe | 1 | 8.303 | 0.000 | 1.312 | 93.61 | 16.97 | 98.92 |
| 101679/101680 | 58959-59-3 | 4.9Ni + 0.7Re | 1 | 8.693 | 0.000 | 1.248 | 115.56 | 13.07 | 102.03 |
| 101723 | 58959-130-2 | 2.5Co + 0.45Pd + 2.4Re | 2 | 7.76 | 0.49 | 1.24 | 66.83 | 22.37 | 99.83 |
| 101679/101680 | 58120-46-2 | 1Re | 1 | 8.670 | 0.000 | 1.120 | 101.92 | 13.30 | 100.26 |
| 101710 | 58120-46-2 | 1Re | 1 | 8.964 | 0.520 | 0.990 | 115.69 | 10.36 | 109.33 |
| 101679/101680 | 58959-59-5 | 4.9Ni + 0.7Re | 1 | 9.570 | 0.000 | 0.728 | 204.97 | 4.30 | 104.51 |
| 101740 | 58959-136-6 | 1Rh | 1 | 10.63 | 0.03 | 0.70 | −133.63 | −6.31 | 115.25 |
| 101710 | 58959-65-3 | 4.6Ni + 0.657Re | 1 | 9.517 | 0.555 | 0.561 | 140.49 | 4.83 | 110.19 |
| 101740 | 58959-136-7 | 5Fe + 1Pt | 1 | 11.83 | 0.03 | 0.37 | −24.41 | −18.25 | 123.09 |
| 101710 | 58959-118-4 | 2.5Co + 0.45Pd + 2.4Re | 1 | 9.726 | 0.481 | 0.175 | 77.13 | 2.74 | 106.51 |
| 101679/101680 | 58959-60-3 | 1Au | 1 | 10.844 | 0.000 | 0.171 | −24.54 | −8.44 | 110.51 |
| 101679/101680 | 58959-116-2 | 2.5Co + 0.45Pd + 2.4Fe | 1 | 10.234 | 0.000 | 0.156 | −80.67 | −2.34 | 104.22 |
| 101679/101680 | 58959-116-3 | 2.5Co + 0.45Pd + 0.73Fe | 1 | 10.368 | 0.000 | 0.152 | −50.17 | −3.68 | 105.52 |
| 101710 | 58959-118-2 | 2.5Co + 0.45Pd + 2.4Re | 1 | 9.979 | 0.522 | 0.148 | 867.70 | 0.21 | 109.33 |
| 101679/101680 | 58959-60-2 | 1Au | 1 | 11.044 | 0.000 | 0.143 | −16.55 | −10.44 | 112.17 |
| 101740 | 58959-136-8 | 5Fe + 1Pd | 1 | 12.03 | | 0.14 | −8.43 | −20.34 | 122.05 |
| 101679/101680 | | | 1 | 10.926 | 0.000 | 0.140 | −18.33 | −9.26 | 110.96 |
| 101710 | 58959-73-1 | 4.9Ni + 1.5Re | 1 | 9.395 | 0.471 | 0.110 | 22.09 | 6.05 | 102.27 |
| 101710 | | | 1 | 9.860 | 0.497 | 0.101 | 87.55 | 1.40 | 107.20 |
| 101740 | | | 1 | 12.78 | | 0.09 | −4.13 | −27.78 | 128.93 |
| 101679/101680 | 58959-60-1 | 4.9Ni + 0.7Re | 1 | 10.557 | 0.000 | 0.074 | −16.15 | −5.57 | 106.47 |
| 101723 | norit rox 0.8 | | 2 | 9.47 | 0.57 | 0.04 | 8.24 | 5.34 | 103.58 |
| 101723 | | | 2 | 10.10 | 0.67 | 0.03 | −41.34 | −0.99 | 111.36 |

The data obtained for presentation in Tables 1 and 2 utilized batch testing of catalysts. The numerous catalysts were prepared using incipient wetness techniques in batches from 25 to 100 g. Forty mg of each catalyst were weighed into 1.4 ml vials and the vials placed on a 96-well plate. The catalysts were manually loaded in the extrudate or granular form that they were prepared. The 96-well plate was loaded into a reactor and placed in a furnace and reduced under flow of pre-heated H₂ (100 ml/min) using one of two temperature profiles: (1) ramp 1.5° C./min to 285° C., hold 4 hrs., cool oven to 190° C., hold 8 hrs.; or (2) ramp 1.5° C./min to 320° C., hold 4 hrs. Upon completion of the heating cycle, the catalysts were cooled under a low flow of N₂. The sealed reactor was transferred to a glove box and opened. Each catalyst was added at minimum in duplicate.

Feedstocks were added to the 96 individual vials. The feedstock was a premixed solution of 10 weight percent glycerol and 0.87 weight percent NaOH. Solutions were added using an automatic 8-tip pipette into each of the 96 vials. The 96-well plate was covered with a GORE-TEX® (W. L. Gore & Associates, Inc. Newark Del.) membrane and stainless-steel cover plate and placed inside the high pressure reactor. The reactor was sealed under N₂ atmosphere, removed from the glove box and placed into a heated orbital shaker. The reactor was charged with 400 psi H₂ at room temperature and heated to the operating temperature of 200° C. At temperature the reactor was pressurized to 1200 psi H₂. The reactor was agitated at 700 rpm for 4 hrs. at which point agitation was halted and the reactor allowed to cool before venting.

The 96-well plate was removed from the reactor and centrifuge at 3,000 rpm for 30 min. Samples were robotically diluted and transferred to a second plate for high pressure liquid chromatography (HPLC) analysis. These samples were injected onto an AMINEX® (Bio-Rad Laboratories, Inc. Hercules Calif.) Fast Acid column and analyzed by refractive index on an AGILENT® (Agilent Technologies, Inc. Santa Clara Calif.) 1100 series HPLC. The HPLC method utilized a flow rate of 1 ml/min.; column temperature of 65° C., and an aqueous 0.005M H₂SO₄ mobile phase.

The results from the HPLC were recorded and duplicate catalyst tests averaged. The average results were used to calculate product selectivity, feed conversion and molar balances. The results were used to assess the ranking of the various catalysts in order of product concentration.

The data presented in Tables 1 and 2 are listed in descending order of propylene glycol concentration. Visualization of the results is provided in the FIGURE, which shows glycerol concentration versus propylene glycol concentration. In the visualization, catalysts that are in the upper left quadrant were most effective, those in the lower right quadrant were lease effective, under the conditions employed.

The batch scale runs were performed with the intent to generate leads for catalysts that would be successful in trickle-bed flow reactors. It is to be noted that there are fundamental differences between running batch reactions and flow reactions. The batch reactions were not only much smaller scale, but they are analogous to running a flooded bed reactor where the gas must be dissolved in the reaction solution in order to be present at the catalytic sites. In contrast, trickle-bed reactors have better mass transport capabilities, and therefore are not limited to the H₂ dissolved in the reaction solution.

Another important consideration, specific to this set of data but experienced throughout most screening of this nature, is that catalyst reduction is not optimized. The catalysts are reduced in batches of 96 using a general reduction profile. Optimization of catalyst reduction would be overly tedious for the volume of sorted catalysts being screened. It is known that proper reduction of catalysts can greatly affect performance. Batch experiments conducted have determined the effects of reduction profile and have found that groups of catalysts (usually grouped by primary metal) do have ranges that activate them most effectively. The general reduction profile utilized does fit the broad range of catalysts being tested.

A final consideration is that the molar balance is a relative calculation based on the concentration data. Due to water loss from the vials and solution mass measurements being tedious, actual mg or moles of feed from the liquid chromatography data were not able to be derived. Water loss is fairly consistent across a plate, but is not necessarily consistent between plates. Unaccounted for water loss leads to exaggerated concentrations. These elevated concentrations carried forward through the calculations can cause understated conversions and amplified molar balances. Molar balances in excess of 100 are evidence of significant water loss.

A subset of the catalysts presented in Tables 1 and 2 was tested under continuous flow conditions in a trickle-bed reactor. The catalysts were chosen from the batch study to be tested in a 30 cc continuous flow reactor. The catalysts tested included the following metal compositions: 5% Ru; 5% Ru+1% Cd; 5% Ru+1% Sn; 5% Ru+1% Pb; 5% Ru+1% Cu; 1% Rh; 5% Fe+1% Rh; and 5% Os+1% Rh. Each was prepared on NORIT® (General Norit Company Limited, Amersfoort Netherlands) ROX 0.8.

Thirty cc of catalyst were packed into a down flow trickle-bed reactor. The catalyst was reduced by raising the temperature of the reactor 1.5° C./min to 285° C. During the ramp a 25-35% H₂ and N₂ gas mixture was passed over the catalyst at 250 sccm. Once temperature was reached the H₂ concentration in the gas mixture was increased to 100% and the temperature was held for 4 hrs. Finally, the reactor temperature was lowered to 190° C., the gas flow rate was increased to 450 sccm and the pressure was raised to 1200 psig. Glycerol feed was started at a rate of 1.7 LHSV (50 ml/hr). The glycerol feed use consisted of 40 wt % desalted glycerol and 2.1 wt percent NaOH in water.

The results of the continuous flow reactor tests are presented in Tables 3, 4 and 5.

TABLE 3
Continuous Flow Reduction of Glycerol on Ru catalysts

| System Conditions | F76-1 | F79-1 | F85-1 | F86-2 | F87-2 |
|---|---|---|---|---|---|
| Catalyst No. | 58959-85-1 | 58959-119-2 | 58959-136-2 | 58959-136-3 | 58959-136-1 |
| Metal Compositions | 5% Ru + 1% Cd | 5% Ru | 5% Ru + 1% Sn | 5% Ru + 1% Cu | 5% Ru + 1% Pb |
| Hours on stream | 43:58:00 | 22:05:00 | 23:42:00 | 71:36:00 | 23:17:00 |
| Cat. Bed Temp (° C.) | 190 | 190 | 190 | 190 | 190 |
| System Pressure | 1200 | 1200 | 1200 | 1200 | 1200 |
| Liq. Feed Rate (ml/hr) | 50 | 50 | 50 | 50 | 50 |
| Glycerol Feed Concentration (wt %) | 35.71 | 34.76 | 43.28 | 40.20 | 40.03 |
| Glycerol Source | ADM | ADM | ADM | ADM | ADM |
| NaOH Feed Concentration (wt %) | 2.10 | 2.10 | 2.10 | 2.10 | 2.10 |
| H2/Glycerol Molar Feed Ratio | 5 | 5 | 5 | 5 | 5 |
| H2 Flow Rate (SCCM) | 450 | 450 | 450 | 450 | 450 |
| % Wt. Recovery | 97.44 | 95.98 | 99.47 | 98.76 | 99.64 |
| % Carbon Recovery | 96.46 | 96.19 | 97.56 | 96.59 | 95.45 |
| Glycerol Conversion (By Difference) | 0.97 | 0.90 | 0.78 | 0.87 | 0.88 |
| LHSV (cc feed/cc cat/h) | 1.67 | 1.67 | 1.67 | 1.67 | 1.67 |
| WHSV (g gly/g cat/h) | 1.35 | 1.35 | 1.63 | 1.49 | 1.51 |
| Space Time Yield (g PG/cc cat/h) | 0.47 | 0.42 | 0.47 | 0.48 | 0.48 |

Selectivities

| | | | | | |
|---|---|---|---|---|---|
| PG C Molar Selectivity | 0.907 | 0.919 | 0.936 | 0.932 | 0.923 |
| Lactate C Molar Selectivity | 0.029 | 0.016 | 0.018 | 0.015 | 0.014 |
| EG C Molar Selectivity | 0.021 | 0.032 | 0.028 | 0.032 | 0.034 |
| Methanol C molar Selectivity | 0.006 | 0.004 | 0.007 | 0.006 | 0.009 |
| Ethanol C Molar Selectivity | 0.013 | 0.010 | 0.003 | 0.004 | 0.009 |
| Propanol (1&2) C Molar Selectivity | 0.0032 | 0.0006 | 0.0015 | 0.0005 | 0.0005 |

TABLE 4
Continuous Flow Reduction of Glycerol on Rh catalysts

| System Conditions | F78-1 | F78-2 | F80-2 | F80-3 | F84-1 |
|---|---|---|---|---|---|
| Catalyst No. | 58959-128-1 | | 58959-128-2 | | 58959-136-6 |
| Metal Composition | 5% Fe + 1% Rh | | 5% Os + 1% Rh | | 1% Rh |
| Hours on stream | 23:13:00 | 47:47:00 | 71:19:00 | 95:45:00 | 23:41:00 |
| Cat. Bed Temp (° C.) | 190 | 190 | 190 | 190 | 190 |
| System Pressure | 1200 | 1200 | 1200 | 1200 | 1200 |
| Liq. Feed Rate (ml/hr) | 50 | 50 | 50 | 50 | 50 |
| Glycerol Feed Concentration (wt %) | 34.76 | 34.76 | 34.98 | 34.98 | 35.64 |
| Glycerol Source | ADM | ADM | ADM | ADM | ADM |
| NaOH Feed Concentration (wt %) | 2.10 | 2.10 | 2.10 | 2.10 | 2.10 |
| H2/Glycerol Molar Feed Ratio | 5 | 5 | 5 | 5 | 5 |
| H2 Flow Rate (SCCM) | 450 | 450 | 450 | 450 | 450 |
| % Wt. Recovery | 97.88 | 98.01 | 97.83 | 97.16 | 97.59 |
| % Carbon Recovery | 95.89 | 95.54 | 96.92 | 97.21 | 98.72 |
| Glycerol Conversion (By Difference) | 0.92 | 0.92 | 0.77 | 0.78 | 0.32 |
| LHSV (cc feed/cc cat/h) | 1.67 | 1.67 | 1.67 | 1.67 | 1.67 |
| WHSV (g gly/g cat/h) | 1.25 | 1.25 | 1.46 | 1.46 | 1.60 |
| Space Time Yield (g PG/cc cat/h) | 0.44 | 0.43 | 0.38 | 0.38 | 0.16 |

Selectivities

| | | | | | |
|---|---|---|---|---|---|
| PG C Molar Selectivity | 0.919 | 0.927 | 0.940 | 0.939 | 0.954 |
| Lactate C Molar Selectivity | 0.019 | 0.017 | 0.021 | 0.020 | 0.013 |
| EG C Molar Selectivity | 0.026 | 0.027 | 0.028 | 0.028 | 0.020 |
| Methanol C molar Selectivity | 0.000 | 0.000 | 0.000 | 0.000 | 0.000 |
| Ethanol C Molar Selectivity | 0.021 | 0.016 | 0.004 | 0.004 | 0.008 |
| Propanol (1&2) C Molar Selectivity | 0.0034 | 0.0034 | 0.0000 | 0.0000 | 0.0001 |

For the Ru-based catalysts the Ru/Cd catalyst was particularly active giving a 97% conversion, significantly higher than for Ru alone. The high activity of the catalyst allows for operation at lower temperature and/or lower base loading. However, at decreased base loading the activity was significantly lower than the Co/Pd/Re or the Ni/Re catalyst. Cu and Pd were also shown to be effective co-metals with Ru. Ru—Cu in particular gave high selectivity, much higher selectivity than Ru alone.

The Rh-series of catalysts were also very effective. Fe—Rh was both active and selective. Os—Rh proved less active. The Rh control was significantly less active than either of the mixed Rh catalysts.

TABLE 5
Continuous Flow Reduction of Glycerol on Ru/Cd catalysts

| System Conditions | F76-1 | F76-2 | F76-3 | F76-4 | F76-6 | F76-7 |
|---|---|---|---|---|---|---|
| F76 5% Ru + 1% Cd, 58959-85-1 | | | | | | |
| Hours on stream | 43:58:00 | 68:49:00 | 92:57:00 | 123:05:00 | 216:28:00 | 260:34:00 |
| Cat. Bed Temp (° C.) | 190 | 190 | 190 | 190 | 190 | 190 |
| System Pressure | 1200 | 1200 | 1200 | 1200 | 1200 | 1200 |
| Liq. Feed Rate (ml/hr) | 50 | 50 | 50 | 25 | 25 | 50 |
| Glycerol Feed concentration (wt %) | 35.71 | 35.71 | 43.58 | 43.58 | 44.95 | 35.52 |
| Glycerol Source | ADM | ADM | ADM | ADM | ADM | ADM |
| NaOH Feed concentration (wt %) | 2.10 | 2.10 | 0.50 | 0.50 | 0.00 | 1.00 |
| H2/Glycerol Molar Feed Ratio | 5 | 5 | 5 | 5 | 5 | 5 |
| H2 Flow Rate (SCCM) | 450 | 450 | 450 | 252 | 252 | 454 |
| % Wt. Recovery | 97.44 | 97.94 | 97.05 | 98.98 | 92.12 | 96.81 |
| % Carbon Recovery | 96.46 | 94.70 | 99.02 | 99.58 | 98.67 | 95.64 |
| Glycerol Conversion (By Difference) | 0.97 | 0.98 | 0.61 | 0.73 | 0.13 | 0.86 |
| LHSV (cc feed/cc cat/h) | 1.67 | 1.67 | 1.67 | 0.83 | 0.83 | 1.67 |
| WHSV (g gly/g cat/h) | 1.35 | 1.35 | 1.65 | 0.83 | 0.85 | 1.35 |
| Space Time Yield (g PG/cc cat/h) | 0.47 | 0.47 | 0.39 | 0.23 | 0.04 | 0.42 |

Selectivities

| | | | | | | |
|---|---|---|---|---|---|---|
| PG C Molar Selectivity | 0.907 | 0.920 | 0.964 | 0.963 | 0.990 | 0.947 |
| Lactate C Molar Selectivity | 0.029 | 0.031 | 0.007 | 0.008 | 0.000 | 0.020 |
| EG C Molar Selectivity | 0.021 | 0.020 | 0.016 | 0.015 | 0.010 | 0.017 |
| Methanol C molar Selectivity | 0.006 | 0.000 | 0.000 | 0.000 | 0.000 | 0.000 |
| Ethanol C Molar Selectivity | 0.013 | 0.012 | 0.003 | 0.004 | 0.000 | 0.004 |
| Propanol (1&2) C Molar Selectivity | 0.0032 | 0.0018 | 0.0007 | 0.0007 | 0.0000 | 0.0000 |

Catalysts of the invention show increased glycerol reduction, increased selectivity to propylene glycol, or both, resulting in increased product yield relative to conventional catalysts. These catalysts may also be used for the reduction (hydrogenolysis) of alternative polyols to produce one or more lower molecular weight polyol(s). In particular applications, the production of lower molecular weight polyols may be selective.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A catalyst comprising catalytic metal components consisting of:
a first metal component comprising Co;
a second metal component comprising at least one member of the group consisting of Fe, Mn, Ru, Os, Rh, Ir, Ni, Pd, Pt, Ag, Au, and Zn; and
optionally one or more of Cr, Mo, W and Cu.

2. The catalyst of claim 1 wherein the first metal component is present in the catalyst at from 0.5% to 20% by weight

3. (canceled)

4. The catalyst of claim 1 wherein the catalyst further comprises a support material comprising one or more of a carbon based support material, zirconium oxide, titanium oxide, niobium oxide, tin oxide, lanthanum oxide, tungsten oxide, silicon carbide, silicon oxycarbide, titanium carbide, titanium oxycarbide, zirconium carbide, zirconium oxycarbide, tungsten carbide and tungsten oxycarbide.

5. A catalyst comprising catalytic metal components consisting of:
a first metal component comprising Os;
a second metal component comprising a member selected from the group consisting of Go, Mn, Re, Ru, Fe, Ir, Ag, Au, Zn, Ni, Pd, Pt, Rh, and Cu, the second metal component differing from the first metal component; and
optionally one or more of Cr, Mo and W.

6. A catalyst comprising catalytic metal components consisting of:
a first metal component comprising Fe; and
a second metal component comprising a member selected from the group consisting of Mn, Ru, Os, Ir, Ag, Au, Zn, Pd, Pt, and Rh; and
optionally one or more of Mo and W.

7. The catalyst of claim 6 wherein the first metal component is present in the catalyst at from 0.5% to 20% by weight.

8. (canceled)

9. The catalyst of claim 6 wherein the catalyst further comprises a support material comprising one or more of a carbon based support material, zirconium oxide, titanium oxide, niobium oxide, tin oxide, lanthanum oxide, tungsten oxide, silicon carbide, silicon oxycarbide, titanium carbide, titanium oxycarbide, zirconium carbide, zirconium oxycarbide, tungsten carbide and tungsten oxycarbide.

10. (canceled)

11. The catalyst of claim 5 wherein the first metal component is present in the catalyst at from 0.5% to 20% by weight.

12. (canceled)

13. The catalyst of claim 5 wherein the catalyst further comprises a support material comprising one or more of a carbon based support material, zirconium oxide, titanium oxide, niobium oxide, tin oxide, lanthanum oxide, tungsten oxide, silicon carbide, silicon oxycarbide, titanium carbide, titanium oxycarbide, zirconium carbide, zirconium oxycarbide, tungsten carbide and tungsten oxycarbide.

14. A hydrogenation catalyst comprising catalytic metal component consisting of:
Ru or Rh;
one or more elements selected from the group consisting of Cd, Sn, Cu, Pb, Bi, Au, Ag, Ga, Fe, Os and Te.

15. The hydrogenation catalyst of claim 14 comprising Ru and an element selected from the group consisting of Cd, Sn, Cu, Pb, Bi, Au, Ag, Ga and Te.

16. The catalyst of claim 15 comprising from 0.5% to 20% Ru, by weight.

17. The catalyst of claim 15 wherein the catalyst further comprises a support material comprising one or more of a carbon based support material, zirconium oxide, titanium oxide, niobium oxide, tin oxide, lanthanum oxide, tungsten oxide, silicon carbide, silicon oxycarbide, titanium carbide, titanium oxycarbide, zirconium carbide, zirconium oxycarbide, tungsten carbide and tungsten oxycarbide.

18. The hydrogenation catalyst of claim 14 comprising Rh and an element selected from the group consisting of Fe and Os.

19. The catalyst of claim 18 comprising from 0.5% to 20% Rh, by weight.

20. The catalyst of claim 18 wherein the catalyst further comprises a support material comprising one or more of a carbon based support material, zirconium oxide, titanium oxide, niobium oxide, tin oxide, lanthanum oxide, tungsten oxide, silicon carbide, silicon oxycarbide, titanium carbide, titanium oxycarbide, zirconium carbide, zirconium oxycarbide, tungsten carbide and tungsten oxycarbide.

21. A hydrogenation catalyst comprising catalytic metal components consisting of:
one or both of Ni and Go; and
one or more elements selected from the group consisting of Mn, Fe, Ag, Au, Mo and Rh.

22. The catalyst of claim 21 comprising from 0.5% to 20% of Ni, Co or Ni and Go, by weight.

23. The catalyst of claim 21 wherein the catalyst further comprises a support material comprising one or more of a carbon based support material, zirconium oxide, titanium oxide, niobium oxide, tin oxide, lanthanum oxide, tungsten oxide, silicon carbide, silicon oxycarbide, titanium carbide, titanium oxycarbide, zirconium carbide, zirconium oxycarbide, tungsten carbide and tungsten oxycarbide.
